(19) United States
(12) Patent Application Publication
(10) Pub. No.: US 2026/0022638 A1
(43) Pub. Date: Jan. 22, 2026

(54) METHODS AND APPARATUS TO PROVIDE WEIGHT REDUCTION OF AN AIRFOIL USING AN INTERNAL LATTICE STRUCTURE

(71) Applicant: General Electric Company, Schenectady, NY (US)

(72) Inventors: Nitesh Jain, Bengaluru (IN); Abhijeet Jayshingrao Yadav, Bengaluru (IN); Balaraju Suresh, Bengaluru (IN); Nicholas J. Kray, Evendale, OH (US); Kirti Arvind Petkar, Bengaluru (IN); Ravindra Shankar Ganiger, Bengaluru (IN); Shawn P. Riley, Evendale, OH (US)

(21) Appl. No.: 18/666,372

(22) Filed: May 16, 2024

(51) Int. Cl. F01D 5/14

(52) U.S. Cl. CPC F01D 5/147

(57) ABSTRACT

Methods and apparatus to provide weight reduction of an airfoil using an internal lattice structure are disclosed herein. An example blade includes a spar and an airfoil coupled to the spar, the airfoil including: an outer surface defining an external contour of the airfoil and defining an inner cavity; and an internal lattice structure arranged in the inner cavity, the internal lattice structure including: a first set of at least two adjacent first unit cells at a first location, the first unit cells having a first structure; and a second set of at least two adjacent second unit cells at a second location, the second set different than the first set, the second unit cells having a second structure different than the first structure, wherein the first structure and the second structure are based on at least one environmental factor impacting the respective first and second locations of the airfoil.

### FIELD OF THE DISCLOSURE

This disclosure relates generally to fan blades and, more particularly, to methods and apparatus to provide weight reduction of an airfoil using a hollow skin with internal lattice structure.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

### BRIEF DESCRIPTION OF THE DRAWINGS

FIG. 1 is a cross-sectional view of an example turbofan gas turbine engine in which examples disclosed herein may be implemented.

FIG. 2 is a cross-sectional view of an example open rotor engine in which examples disclosed herein may be implemented.

FIG. 3 is a cross sectional view of the example blade of FIGS. 1-2, wherein the example blade includes example latticed regions in accordance with the teachings of this disclosure.

FIG. 4A illustrates a first example unit cell structure implemented by the example latticed regions of FIG. 3 in accordance with the teachings of this disclosure.

FIG. 4B illustrates a second example unit cell structure implemented by the example latticed regions of FIG. 3 in accordance with the teachings of this disclosure.

FIG. 4C illustrates a third example unit cell structure implemented by the example latticed regions of FIG. 3 in accordance with the teachings of this disclosure.

FIG. 4D illustrates a fourth example unit cell structure implemented by the example latticed regions of FIG. 3 in accordance with the teachings of this disclosure.

FIG. 4E illustrates a fifth example unit cell structure implemented by the example latticed regions of FIG. 3 in accordance with the teachings of this disclosure.

FIG. 5 is cross-sectional view of the example blade of FIGS. 1-2, wherein the example blade includes a complex 3D structure in accordance with the teachings of this disclosure.

FIG. 6 is a cross-sectional view of the example blade of FIGS. 1-2, wherein the example blade includes example latticed regions and example non-latticed regions in accordance with the teachings of this disclosure.

FIG. 7 is a cross-sectional view of the example blade of FIGS. 1-2, wherein the spar includes example latticed regions.

FIG. 8 is a flowchart representative of an example method to generate the configuration of the example blade of FIG. 3 in accordance with the teachings of this disclosure.

FIG. 9 is a flowchart representative of an example method to manufacture the example blade of FIG. 3 in accordance with the teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is, therefore, provided to describe example implementations and not to be taken limiting on the scope of the subject matter described in this disclosure. Certain features from different aspects of the following description may be combined to form yet new aspects of the subject matter discussed below.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

The term “metallic” as used herein is indicative of a material that includes metal such as, but not limited to, titanium, iron, aluminum, stainless steel, and nickel alloys. A metallic material or alloy can be a combination of at least two or more elements or materials, where at least one is a metal.

The basic operation of a gas turbine implemented in connection with a turbofan engine of a propulsion system of an aircraft includes an intake of fresh atmospheric air flow through the front of the turbofan engine with a fan. In the operation of a turbofan engine, a first portion of the intake air bypasses a core gas turbine engine of the turbofan to produce thrust directly. A second portion of the intake air travels through a booster compressor (e.g., a first compressor) located between the fan and a high-pressure compressor (e.g., a second compressor) in the core gas turbine engine (e.g., the gas turbine). The booster compressor is used to raise or boost the pressure of the second portion of the intake air prior to the air flow entering the high-pressure compressor. The air flow can then travel through the high-pressure compressor that further pressurizes the air flow. The booster compressor and the high-pressure compressor each include a group of blades attached to a rotor and/or shaft. The blades spin at high speed relative to stationary vanes and each rotation of the blades subsequently compresses the air flow. The high-pressure compressor then feeds the pressurized air flow to a combustion chamber (e.g., combustor). In some examples, the high-pressure compressor feeds the pressurized air flow at speeds of hundreds of miles per hour. In some instances, the combustion chamber includes one or more rings of fuel injectors that inject a steady stream of fuel into the combustion chamber, where the fuel mixes with the pressurized air flow. A secondary use of the compressors, particularly the high-pressure compressor, is to bleed air for use in other systems of the aircraft (e.g., cabin pressure, heating, and air conditioning, etc.).

In the combustion chamber of the core gas turbine engine, the fuel is ignited with an electric spark provided by an igniter, where the fuel in some examples burns at temperatures of more than 2000 degrees Fahrenheit. The resulting combustion produces a high-temperature, high-pressure gas stream (e.g., hot combustion gas) that passes through another group of blades called a turbine. The turbine can include a low-pressure turbine and a high-pressure turbine, for example. Each of the low-pressure turbine and the high-pressure turbine includes an intricate array of alternating rotating blades and stationary airfoil-section blades (e.g., vanes). The high-pressure turbine is located axially downstream from the combustor and axially upstream from the low-pressure turbine. As the hot combustion gas passes through the turbine, the hot combustion gas expands through the blades and/or vanes, causing the rotating blades coupled to rotors of the high-pressure turbine and the low-pressure turbine to spin.

The rotating blades of the high-pressure turbine and the low-pressure turbine serve at least two purposes. A first purpose of the rotating blades is to drive the fan, the high-pressure compressor, and/or the booster compressor to draw more pressured air into the combustion chamber, which increases an amount of compressed air ignited by the engine to generate thrust to propel an aircraft. For example, in a dual-spool design of a turbofan, the low-pressure turbine (e.g., a first turbine) can be attached to and in force-transmitting connection with the booster compressor (e.g., the first compressor) and fan via a first shaft, collectively referred to as a first spool of the gas turbine, such that the rotation of a rotor of the low-pressure turbine drives a rotor of the booster compressor and the fan. For example, a high-pressure turbine (e.g., a second turbine) can be attached to and in force transmitting connection with the high-pressure compressor (e.g., a second compressor) via a second shaft coaxial with the first shaft, collectively referred to as a second spool of the gas turbine, such that the rotation of a rotor of the high-pressure turbine drives a rotor of the high-pressure compressor. A second purpose of the rotating blades is to spin a generator operatively coupled to the turbine section to produce electricity. For example, the turbine can generate electricity to be used by an aircraft, a power station, etc.

It is generally an object of the design of aircraft engines such as turbofans to generate as much thrust as possible given the static, dynamic, centrifugal, and/or thermal stress limitations and weight considerations of aspects of the core gas turbine engine, and/or the turbofan engine, while limiting the weight of the engine. An important metric of aircraft engines is the thrust to weight ratio of the engine. One of the ways to increase the thrust to weight ratio of an engine is to reduce the weight of the engine. One of the heaviest components of the engine are the blades in the engine. Thus, it is an object of aircraft engine design to minimize or otherwise reduce the weight of the blades. Though examples disclosed herein are discussed in connection with a turbofan jet engine, it is understood that examples disclosed herein can be implemented in connection with a turbojet jet engine, a turboprop jet engine, a combustion turbine for power production, or any other suitable application where it is desired to increase the thrust to weight ratio of an aircraft.

The example low-pressure compressor and high-pressure compressor of the turbine engine of the turbofan each include one or more stages. Each stage includes an annular array of compressor blades (e.g., first airfoils) mounted about a central rotor paired with an annular array of stationary compressor vanes (e.g., second airfoils) spaced apart from the rotor and fixed to a casing of the compressor. At an aft portion of a compressor stage, rotation of the rotor and accompanying blades provides an increase in velocity, temperature, and pressure of air flow. At a fore portion of the compressor stage, the air flow diffuses (e.g., loses velocity) across compressor vanes providing for an increase in pressure. The implementation of multiple stages across the low-pressure compressor and high-pressure compressor provides for the compression ratios to operate a jet engine such as a turbofan.

In the example of the high-pressure compressor and the low-pressure compressor, compressor blades (also referred to herein as blades and/or dovetail blades) are arrayed about a corresponding high-pressure compressor rotor and low-pressure compressor rotor, respectively. The high-pressure rotor and accompanying compressor blades (e.g., blades, dovetail blades, etc.) can be fashioned from titanium alloys (e.g., a titanium-aluminum alloy, a titanium-chromium alloy, etc.) and/or steel alloys (e.g., a steel-chromium alloy), etc. For example, to increase ease of maintenance and assembly, replaceability of blades, and/or modularity of the high-pressure compressor, discrete compressor blades are mounted in series annularly about the high-pressure rotor to achieve a substantially uniform distribution annularly about the rotor. For this purpose, an example compressor blade implemented in accordance with the teachings of this disclosure includes an airfoil portion and a mounting portion (e.g., a root, a spar). The airfoil portion of the compressor blade causes velocity, pressure, and temperature increases to the air flow. The mounting portion of the compressor blade enables mounting of blade to the rotor. In some examples, the geometry of the airfoil portion and/or mounting portion can be different for the compressor blades of each stage of the high-pressure compressor and the same for the compressor blades within each stage of the high-pressure compressor.

In some propeller or open-rotor engine applications, high loading is experienced during various phases of the flight. For example, a high vibratory load is experienced during various phases of the flight due to asymmetric propeller loading (e.g., P-Factor or 1P loading). 1P loading, also referred to as +/−1P loading, is typically highest at takeoff, but also may occur at any point at which the airflow is not oriented normal to the engine. Certain examples address +/−1P loading by applying a radial preload to the blade assembly that provides better blade retention and allows for better serviceability. In addition to vibratory stresses, airfoils are subject to mechanical stresses from centrifugal loads, aerodynamic loads, and thermal loads. These loads experienced at one position in an airfoil can be different than these loads experienced at a second position in the airfoil. In some cases, the loads experienced by an airfoil during operation of the engine may result in deflection of the airfoil. Such deflection produces a moment on the root of the blade and, in some cases, may result in wear and/or failure of the blade. In some cases, when there is failure of a blade, a complex disassembly process is completed to remove the blade, which increases the time and work required to service the equipment.

Disclosed herein are example methods and apparatus that provide for increased thrust-to-weight ratio of an aircraft using an airfoil with a hollow skin and an internal lattice structure. Examples disclosed herein provide for selectively placed lattice structures at different locations within the airfoil based on loading requirements (e.g., vibratory stresses, centrifugal loads, aerodynamic loads, and thermal loads, foreign object damage (FOD) requirements, etc.) experienced as a result of environmental factors (e.g., weight of the aircraft and the engine, the size and shape of the blades, the optimal or maximum flight speed of the aircraft, the altitude the aircraft flies at, etc.).

In examples disclosed herein, an airfoil includes an outer surface (also referred to as an outer skin or a first outer surface) defining an external contour of the airfoil and an inner cavity, the outer surface having a pressure side and a suction side. An internal lattice structure is disposed (e.g., arranged, positioned) in the inner cavity, the internal lattice structure including a set of unit cells. Each unit cell of the set has a three-dimensional structure. In some examples, the structure is formed by a plurality of surfaces connecting at a plurality of edges and a plurality of vertices. The plurality of surfaces includes a first surface extending in a first plane and a second surface extending in a second plane different than the first plane. Adjacent unit cells of the set connect at least one of a common surface, a common edge, and/or a common vertex. In some examples, the connection of adjacent unit cells of the set follows a pattern. For example, unit cells that are adjacent in a first direction are connected by a first surface of the structure, and unit cells that are adjacent in a second direction different than the first are connected by a second surface of the structure. For example, the structure may be a hexagonal prism having two bases and four faces, all unit cells that are adjacent in a first direction are connected by a common base and all unit cells that are adjacent in a second direction different than the first are connected by a common face.

In some examples, the internal lattice structure includes a first set (e.g., group, plurality) of first unit cells and a second set of second unit cells, a second structure of the second unit cells different (e.g., by shape, by size, by material, etc.) than a first structure of the first unit cells. In some examples, the first set and the second set have different mechanical properties (e.g., stiffness) as a result of their different structures. For example, the first set may have stronger compressive strength in the chord direction (leading edge to trailing edge) of the airfoil than the second set. In some examples, the internal lattice structure includes more than two sets of different unit cells (e.g., three sets, five sets, etc.). In some examples, the respective sets are selectively positioned (e.g., placed) within the airfoil based on their respective mechanical properties and loading requirements experienced by the airfoil at respective locations due to at least one environmental factor. For example, the second set can have high stiffness and be positioned along a leading edge of the airfoil to meet loading requirements experienced at the leading edge, such as FOD requirements associated with bird strikes, while the first set can have low stiffness and be positioned along a trailing edge of the airfoil as the trailing edge experiences reduced loading requirements compared to the leading edge. Advantageously, by forming the cavity in the airfoil, a weight of the airfoil and/or material costs associated therewith can be reduced and the thrust-to-weight ratio of the aircraft can be increased. Furthermore, by configuring the internal lattice structure to include different unit cell structures in different locations, the airfoil can meet different loading requirements imposed by environmental factors on different locations in the airfoil.

In some examples, the internal lattice structure includes a complex (e.g., composite) three-dimensional structure. In some examples, at least one of the first or second set of unit cells is a complex three-dimensional structure (e.g., a complex 3D-shaped set). A complex 3D structure is a 3D structure that is made from a combination of other basic 3D shapes and polygons. The complex 3D-shaped sets disclosed herein provide unique mechanical properties and functional characteristics that can be tuned across different directions of the sets. In some examples, the complex 3D structure is configured to exhibit mechanical properties that meet loading requirements imposed by environmental factors. Example complex 3D-shaped sets have a high strength to weight ratio, such that they can bear around 14,000 times their own weight. Example complex 3D-shaped sets offer improved energy absorption and reduce stress propagation initiated by a load experienced by the airfoil. Example complex 3D-shaped sets also offer reduced thermal conductivity, reducing damage to the airfoil caused by overheating. Example complex 3D-shaped sets provide improved flexibility and compressibility, allowing the set to adapt to interface conditions. Example complex 3D-shaped sets also exhibit improved resistance to plastic deformation of the structure under loading. In some examples, the complex 3D structure is a self-dampening structure having variable geometry. In some examples, the complex 3D structure is asymmetrical (e.g., has no line of symmetry). In some examples, the complex 3D structure includes impact-absorbing casings and containment structures.

In some examples, the structure of the unit cells can be cross-cubed shaped, diamond shaped, honeycomb shaped, a pentagonal-prism, and/or other three-dimensional geometric shape. In some examples, the first structure has a different shape than the second structure. For example, the first structure can be cross-cube shaped, while the second structure is honeycomb shaped. In some examples, the difference in shape between the first structure and the second structure causes the first set and the second set to have different mechanical properties. In some examples, the structure of the unit cells is that of a 3D cut-and-fold pattern (e.g., a 3D patterned geometric structure such as a kirigami pattern).

In some examples, the structure of the unit cells can vary in ways other than shape. In some examples, the structure of the unit cells can vary by wall thickness. For example, the first structure can be cube-shaped, having first walls and first vertices where the first walls intersect, and the second structure can also be cube-shaped, having second walls and second vertices where the second walls intersect, the thickness of the second walls higher than the thickness of the first walls and the thickness of the second vertices higher than the first vertices, causing the second set to have higher stiffness than the first set. In some examples, the structure of the unit cells varies by material. For example, the first structure can be a first material and the second structure can be a second material, the second material having different mechanical properties (e.g., lower elasticity) than the first material. In some examples, the structure of the unit cells can vary by size. For example, the first structure can be honeycomb shaped having a first cross-sectional area, and the second structure can be honeycomb shaped having a second cross-sectional area lower than the first cross-sectional area. In some examples, the first structure and the second structure differ by any one or more of these variations in structure (e.g., shape, size, material, wall thickness).

In some examples, the airfoil is connected to a spar to form a blade. The spar, also known as a blade root, provides structural support to the airfoil and carries loads (e.g., the weight of the airfoil) separate from the loads carried by the airfoil. In some examples, the spar is a solid structure. In some examples, the spar can include an outer surface (also referred to herein as a second outer surface) defining an external contour of the spar and an internal cavity of the spar and a spar lattice structure positioned in the internal cavity. The spar lattice structure includes a set of unit cells, the unit cells having a structure. In some examples, the spar lattice structure may include a plurality of sets, respective sets having different respective unit cells, the respective unit cells differing by structure. The structures of the unit cells of the spar lattice structure can vary as described above in connection with the internal lattice structure of the airfoil, according to the loading requirement experienced by the spar in different locations within the spar. In some examples, the structures of the unit cells of the spar lattice are different than the structures of the unit cells of the airfoil. In some examples, the spar is integrally formed with the airfoil. In some examples, the spar lattice structure extends into the airfoil and/or is integrally formed with the internal lattice structure of the airfoil.

In some examples, the internal cavity of the airfoil (and/or the internal cavity of the spar) can include a latticed region and a non-latticed region. In some examples, the non-latticed region is hollow. In some examples, the non-latticed region includes structural filler material (e.g., dampening material, foam, polyurethane, etc.) to provide additional stiffness.

In some examples, the sets of unit cells are selectively placed at specific positions within the airfoil to meet the loading requirements of the airfoil at those positions as determined based on at least one environmental factor. Loads experienced can include, but are not limited to, vibratory stresses, centrifugal loads, aerodynamic loads, and thermal loads. Environmental factors can include various characteristics about the aircraft and the engine, such as the weight of the aircraft and the engine, the size and shape of the blades, the optimal or maximum flight speed of the aircraft, the altitude the aircraft flies at, etc. In some examples, the configuration of the internal lattice structure is determined based on predicted loads to be experienced by an airfoil based on the above.

In some examples, the airfoil is a metallic airfoil (e.g., aluminum, titanium, nickel, steel, etc.). In some examples, the airfoil is a composite (e.g., fiberglass, carbon fiber, aramid, etc.) airfoil. In some examples, the outer surface is metallic and the internal lattice structure is composite. In some examples, the outer surface is composite and the internal lattice structure is metallic. In some examples, the spar is metallic, composite or a combination of metallic and composite components. In some examples, the internal lattice structure may be adhesively bonded, welded, brazed, additively manufactured, or any combination of these methods of manufacture. In some examples, the internal lattice structure is formed from a single sheet of material, the sets formed by folding and cutting of the sheet of material.

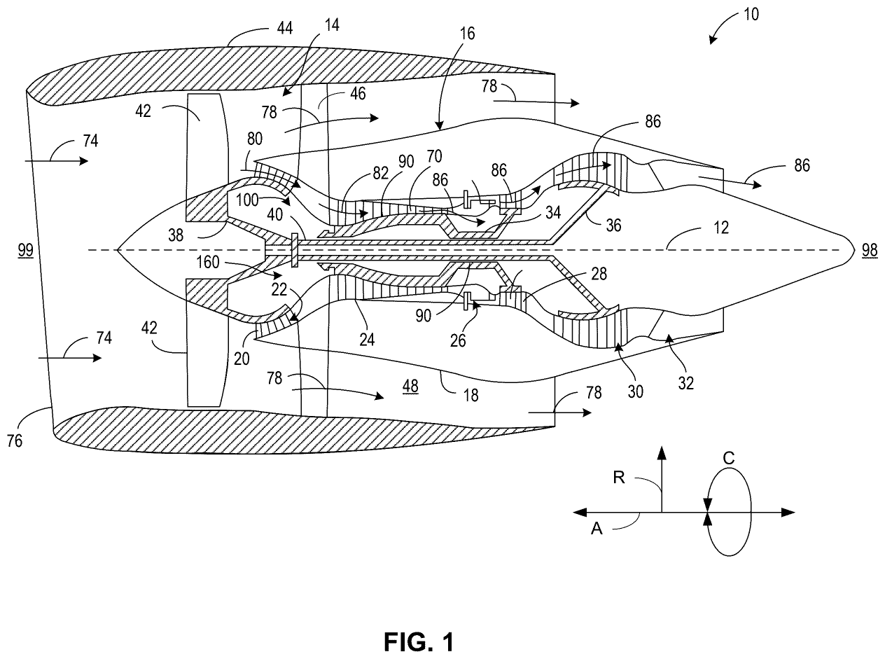

FIG. 1 is a cross-sectional view of a turbofan gas turbine engine in which examples disclosed herein may be implemented. Referring now to the drawings, FIG. 1 is a schematic partially cross-sectioned side view of an exemplary gas turbine engine 10 as may incorporate various examples of the present disclosure. The engine 10 may particularly be configured as a gas turbine engine for an aircraft. Although further described herein as a turbofan engine, the engine 10 may define a turboshaft, turboprop, or turbojet gas turbine engine, including marine and industrial engines and auxiliary power units. As shown in FIG. 1, the engine 10 has a longitudinal or axial centerline axis 12 that extends therethrough for reference purposes. An axial direction A is extended co-directional to the axial centerline axis 12 for reference. The engine 10 further defines an upstream end 99 and a downstream end 98 for reference. In general, the engine 10 may include a fan assembly 14 and a core engine 16 disposed downstream from the fan assembly 14. For reference, the engine 10 defines an axial direction A, a radial direction R, and a circumferential direction C. In general, the axial direction A extends parallel to the axial centerline axis 12, the radial direction R extends outward from and inward to the axial centerline axis 12 in a direction orthogonal to the axial direction A, and the circumferential direction extends three hundred sixty degrees (360°) around the axial centerline axis 12.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a heat addition system 26, an expansion section or turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In certain examples, as shown in FIG. 1, the LP rotor shaft 36 is connected to the fan shaft 38 via a reduction gear 40 such as in an indirect-drive or geared-drive configuration.

As shown in FIG. 1, the fan assembly 14 includes a plurality of fan blades 42 that are coupled to and that extend radially outwardly from the fan shaft 38. An annular fan casing or nacelle 44 circumferentially may surround the fan assembly 14 and/or at least a portion of the core engine 16. It should be appreciated by those of ordinary skill in the art that the nacelle 44 may be configured to be supported relative to the core engine 16 by a plurality of circumferentially-spaced outlet guide vanes (OGVs) or struts 46. Moreover, at least a portion of the nacelle 44 may extend over an outer portion of the core engine 16 so as to define a fan flow passage 48 therebetween. However, it should be appreciated that various configurations of the engine 10 may omit the nacelle 44 or omit the nacelle 44 from extending around the fan blades 42.

It should be appreciated that combinations of the shafts 34, 36, the compressors 22, 24, and the turbines 28, 30 define a rotor assembly 90 of the engine 10. For example, the HP rotor shaft 34, HP compressor 24, and HP turbine 28 may define a high speed or HP rotor assembly of the engine 10. Similarly, combinations of the LP rotor shaft 36, LP compressor 22, and LP turbine 30 may define a low speed or LP rotor assembly of the engine 10. Various examples of the engine 10 may further include the fan shaft 38 and fan blades 42 as the LP rotor assembly. In certain examples, the engine 10 may further define a fan rotor assembly that is at least partially mechanically de-coupled from the LP spool via the fan shaft 38 and the reduction gear 40. Still further examples may further define one or more intermediate rotor assemblies (not shown) defined by an intermediate pressure compressor, an intermediate pressure shaft, and an intermediate pressure turbine disposed between the LP rotor assembly and the HP rotor assembly (relative to serial aerodynamic flow arrangement).

During operation of the engine 10, a flow of air, shown schematically by arrows 74, enters an inlet 76 of the engine 10 defined by the fan case or nacelle 44. A portion of air, shown schematically by arrow 80, enters the core engine 16 through the annular inlet 20 defined at least partially via the outer casing 18. The flow of air is provided in serial flow through the compressors 22, 24, the heat addition system 26, and the expansion section via a core flow path 70. The flow of air 80 is increasingly compressed as it flows across successive stages of the compressors 22, 24, such as shown schematically by arrows 82. The compressed air 82 enters the heat addition system 26 and mixes with a liquid and/or gaseous fuel and is ignited to produce combustion gases 86. It should be appreciated that the heat addition system 26 may form any appropriate system for generating combustion gases, including, but not limited to, deflagrative or detonative combustion systems, or combinations thereof. The heat addition system 26 may include annular, can, can-annular, trapped vortex, involute or scroll, rich burn, lean burn, rotating detonation, or pulse detonation configurations, or combinations thereof.

The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 bypasses the core engine 16 and flows across the fan flow passage 48, such as shown schematically by arrows 78.

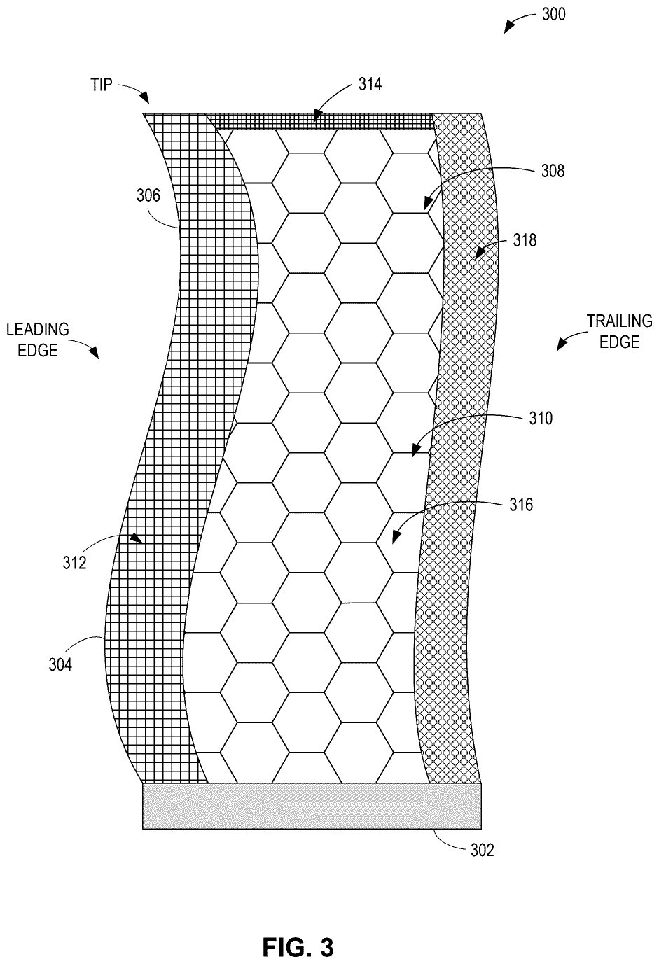

It should be appreciated that FIG. 1 depicts and describes a two-stream engine having the fan flow passage 48 and the core flow path 70. The example depicted in FIG. 1 has a nacelle 44 surrounding the fan blades 42, such as to provide noise attenuation, blade-out protection, and other benefits known for nacelles, and which may be referred to herein as a “ducted fan,” or the entire engine 10 may be referred to as a “ducted engine.” In some examples, one or more of the airfoils described above, such as the fan blades 42, can be implemented with the novel structures disclosed herein in connection with FIGS. 3-9.

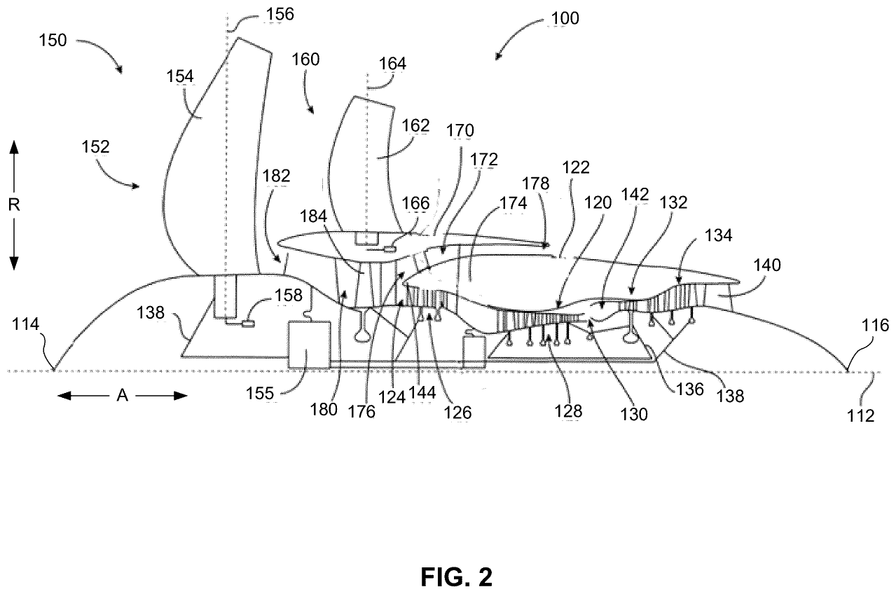

FIG. 2 is a schematic cross-sectional view of an example open-rotor turbine engine according to one example of the present disclosure. Particularly, FIG. 2 illustrates an aviation three-stream turbine engine herein referred to as “three-stream engine 100”. The three-stream engine 100 of FIG. 2 can be mounted to an aerial vehicle, such as a fixed-wing aircraft, and can produce thrust for propulsion of the aerial vehicle. The architecture of the three-stream engine 100 provides three distinct streams of thrust-producing airflow during operation. Unlike the engine 10 shown in FIG. 1, the three-stream engine 100 includes a fan that is not ducted by a nacelle or cowl, such that it may be referred to herein as an “unducted fan,” or the entire engine 100 may be referred to as an “unducted engine.”

For reference, the three-stream engine 100 defines an axial direction A, a radial direction R, and a circumferential direction C. Moreover, the three-stream engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The three-stream engine 100 extends between a forward end 114 and an aft end 116, e.g., along the axial direction A.

The three-stream engine 100 includes a core engine 120 and a fan section 150 positioned upstream thereof. Generally, the core engine 120 includes, in serial flow order, a compressor section, a combustion section, a turbine section, and an exhaust section. Particularly, as shown in FIG. 2, the core engine 120 includes a core cowl 122 that defines an annular core inlet 124. The core cowl 122 further encloses a low pressure system and a high pressure system. In certain examples, the core cowl 122 may enclose and support a booster or low pressure (“LP”) compressor 126 for pressurizing the air that enters the core engine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air. It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example. After driving each of the turbines 132, 134, the combustion products exit the core engine 120 through a core exhaust nozzle 140 to produce propulsive thrust. Accordingly, the core engine 120 defines a core flow path or core duct 142 that extends between the core inlet 124 and the core exhaust nozzle 140. The core duct 142 is an annular duct positioned generally inward of the core cowl 122 along the radial direction R.

The fan section 150 includes a fan 152, which is the primary fan in this example. For the depicted example of FIG. 2, the fan 152 is an open rotor or unducted fan. However, in other examples, the fan 152 may be ducted, e.g., by a fan casing or nacelle circumferentially surrounding the fan 152. As depicted, the fan 152 includes an array of fan blades 154 (only one shown in FIG. 2). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. Optionally, as shown in FIG. 2, the fan 152 can be coupled with the LP shaft 138 via a speed reduction gearbox 155, e.g., in an indirect-drive or geared-drive configuration.

Moreover, the fan blades 154 can be arranged in equal spacing around the longitudinal axis 112. Each blade 154 has a root and a tip and a span defined therebetween. Each blade 154 defines a central blade axis 156. For this example, each blade 154 of the fan 152 is rotatable about its respective central blade axis 156, e.g., in unison with one another. One or more actuators 158 can be controlled to pitch the blades 154 about their respective central blade axis 156. However, in other examples, each blade 154 may be fixed or unable to be pitched about its central blade axis 156.

The fan section 150 further includes a fan outlet guide vane array 160 that includes fan outlet guide vanes 162 (only one shown in FIG. 2) disposed around the longitudinal axis 112. For this example, the fan outlet guide vanes 162 are not rotatable about the longitudinal axis 112. Each fan outlet guide vane 162 has a root and a tip and a span defined therebetween. The fan outlet guide vanes 162 may be unshrouded as shown in FIG. 2 or may be shrouded, e.g., by an annular shroud spaced outward from the tips of the fan outlet guide vanes 162 along the radial direction R. Each fan outlet guide vane 162 defines a central blade axis 164. For this example, each fan outlet guide vane 162 of the fan outlet guide vane array 160 is rotatable about its respective central blade axis 164, e.g., in unison with one another. One or more actuators 166 can be controlled to pitch the fan outlet guide vane 162 about their respective central blade axis 164. However, in other examples, each fan outlet guide vane 162 may be fixed or unable to be pitched about its central blade axis 164. The fan outlet guide vanes 162 are mounted to a fan cowl 170.

As shown in FIG. 2, in addition to the fan 152, which is unducted, a ducted fan 184 is included aft of the fan 152, such that the three-stream engine 100 includes both a ducted and an unducted fan that both serve to generate thrust through the movement of air without passage through core engine 120. The ducted fan 184 is shown at about the same axial location as the fan outlet guide vane 162, and radially inward of the fan outlet guide vane 162. Alternatively, the ducted fan 184 may be between the fan outlet guide vane 162 and core duct 142, or be farther forward of the fan outlet guide vane 162. The ducted fan 184 may be driven by the low pressure turbine 134 (e.g., coupled to the LP shaft 138), or by any other suitable source of rotation, and may serve as the first stage of booster or may be operated separately.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flow path or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The stationary struts 174 may each be aerodynamically contoured to direct air flowing thereby. In some examples, other struts are provided in addition to the stationary struts 174 to connect and support the fan cowl 170 and/or core cowl 122. In many examples, the fan duct 172 and the core cowl 122 may at least partially co-extend (generally axially) on opposite sides (e.g., opposite radial sides) of the core cowl 122. For example, the fan duct 172 and the core cowl 122 may each extend directly from the leading edge 144 of the core cowl 122 and may partially co-extend generally axially on opposite radial sides of the core cowl 122.

The three-stream engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan outlet guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R. In some examples, one or more of the airfoils described above, such as the fan blades 154 and/or the fan outlet guide vanes 162, can be implemented with the novel structures disclosed herein in connection with FIGS. 3-9.

FIG. 3 is a cross-sectional view of an example blade 300. The example blade 300 can be used to implement a variety of blades, including the fan blades 42 of the example turbofan gas turbine engine of FIG. 1 and the fan blades 154 of the example open rotor engine of FIG. 2 described above. In the illustrated example of FIG. 3, the blade 300 includes an example spar (e.g., root) 302 connected to an airfoil 304, the airfoil 304 including an outer surface 306 defining an external contour of the blade 300. The outer surface 306 forms and/or otherwise defines an example inner cavity 308 therein. In this example, a cross-sectional shape of the inner cavity 308 is substantially the same as a cross-sectional shape of the outer surface 306, such that a thickness of the outer surface 306 remains approximately constant along a perimeter of the outer surface. In other examples, the cross-sectional shape of the inner cavity 308 may be different, such that a thickness of the outer surface 306 varies along a perimeter of the outer surface 306. In some examples, the inner cavity 308 further extends in a radial direction of the blade 300 between the core engine 16 and the nacelle 44 of FIG. 1.

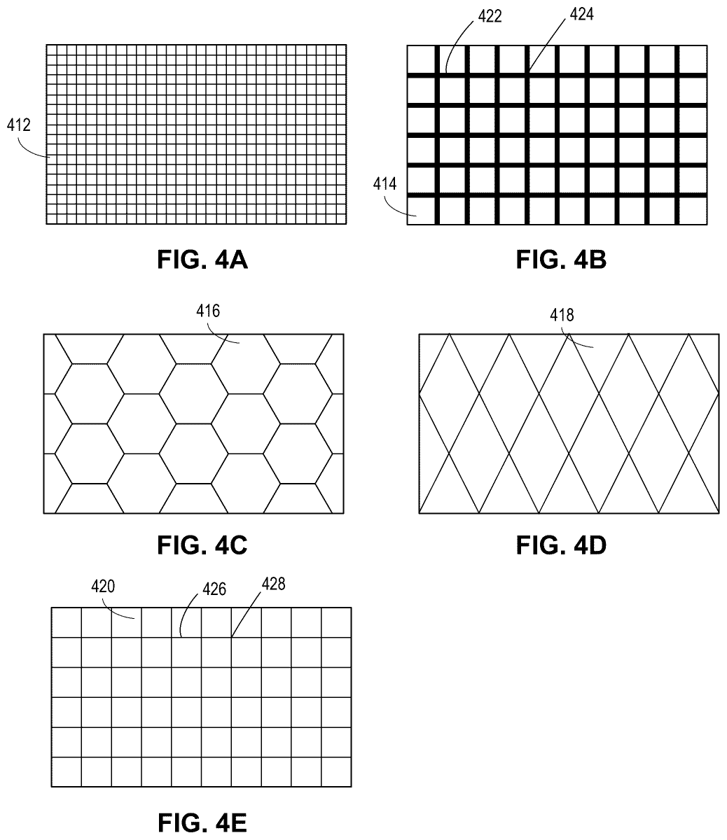

In the illustrated example of FIG. 3, an example internal lattice structure 310 is disposed in the inner cavity 308. The internal lattice structure 310 includes a first set 312 of first unit cells, a second set 314 of second unit cells, a third set 316 of third unit cells and a fourth set 318 of fourth unit cells, where the respective unit cells are illustrated in FIGS. 4A-4E. In some examples, the internal lattice structure 310 includes fewer (e.g., 1, 2, 3) or more (e.g., 5, 6, etc.) sets of unit cells. In the illustrated example of FIG. 3, the first, second, third, and fourth unit cells have respective first, second, third, and fourth structures. In the illustrated example of FIG. 3, each of the first, second, third, and fourth structures is unique. In some examples, one of the first, second, third, or fourth structures may be identical to one of the other first, second, third, or fourth structures. In some examples, the respective first, second, third, and fourth sets 312-318 have different mechanical properties (e.g., stiffness) as a result of the different structures. In some examples, the respective sets 312-318 are selectively positioned (e.g., placed) within the blade 300 based on their respective mechanical properties and loading requirements experienced by the blade at their respective locations due to at least one environmental factor (e.g., vibratory load, centrifugal load, aerodynamic load, thermal load, etc.). For example, the first set 312 can have high stiffness and be positioned along a leading edge of the airfoil to meet loading requirements experienced at the leading edge, while the fourth set 318 can have low stiffness and be positioned along a trailing edge of the airfoil 304 as the trailing edge may experience reduced loading requirements compared to the leading edge.

In the illustrated example of FIG. 3, the airfoil 304 is connected to a spar 302 to form the blade 300. The spar 302, also known as a blade root, provides structural support to the airfoil 304 and carries loads separate from the loads carried by the airfoil 304. In some examples, the spar 302 is a solid structure. In some examples, the spar 302 can include a second outer surface defining an external contour of the spar 302 and an internal cavity of the spar 302 and a spar lattice structure positioned in the internal cavity. The spar lattice structure can include a set of unit cells, the unit cells having a structure. In some examples, the spar lattice structure may include a plurality of sets, respective sets having different respective unit cells, the respective unit cells differing by structure. The structures of the unit cells of the spar lattice structure can vary as described above in connection with the internal lattice structure 310 of the airfoil 304, according to the loading requirements experienced by the spar 302 in different locations within the spar 302. In some examples, the structures of the unit cells of the spar lattice are different than the structures of the unit cells of the airfoil 304. In some examples, the spar 302 is integrally formed with the airfoil 304. In some examples, the spar lattice structure extends into the airfoil 304 and/or is integrally formed with the internal lattice structure 310 of the airfoil 304. In some examples, the airfoil 304 is a metallic airfoil 304 (e.g., aluminum, titanium, nickel, steel, etc.). In some examples, the airfoil 304 is a composite airfoil 304. In some examples, the outer surface 306 is metallic, and the internal lattice structure 310 is composite. In some examples, the outer surface 306 is composite, and the internal lattice structure 310 is metallic. In some examples, the spar 302 is metallic, composite or a combination of metallic and composite components. In some examples, the internal lattice structure 310 can be adhesively bonded, welded, brazed, additively manufactured, and/or any combination of these methods of manufacture. In some examples, the internal lattice structure 310 is formed from a single sheet of material, the sets formed by folding and cutting of the sheet of material.

FIGS. 4A-4E illustrate example unit cell structures implemented by the example internal lattice structure 310 of FIG. 3. In the illustrated examples, the first structure of the first unit cells 412 of FIG. 4A, the second structure of the second unit cells 414 of FIG. 4B, and the fifth structure of the fifth unit cells 420 of FIG. 4E are cross-cube shaped, the third structure of the third unit cells 416 of FIG. 4C is honeycomb-shaped, and the fourth structure of the fourth unit cells 418 of FIG. 4D is diamond-shaped. In some examples, the structure of a given unit cell can be any of the above shapes and/or any other geometric shape. In some examples, the difference in shape between the respective first, second, third, and fourth structures causes the respective first, second, third, and fourth sets 312-318 to have different mechanical properties. In some examples, the structure of the unit cells is that of a 3D cut-and-fold pattern.

In some examples, the structure of the unit cells can vary in ways other than shape. In the illustrated examples of FIGS. 4A-E, the second structure of the second unit cells 414 and fifth structure of the fifth unit cells 420 can vary by wall thickness. For example, as shown in FIGS. 4B and 4E, the second structure has first walls 422 and first vertices 424 where the first walls 422 intersect, and the fifth structure has second walls 426 and second vertices 428 where the second walls 426 intersect, the thickness of the first walls 422 higher than the thickness of the second walls 426 and the thickness of the first vertices 424 higher than the second vertices 428, causing the second unit cells 414 to have higher stiffness than the fifth unit cells 420. In some examples, the structure of the unit cells varies by material. For example, the first unit cells 412 can be a first material (e.g., a first metallic material such as titanium) and the second unit cells 414 can be a second material (e.g., a second metallic material such as aluminum, a composite material such as fiberglass), the second material having different mechanical properties (e.g., lower stiffness) than the first material. In some examples, the structure of the unit cells can vary by size. For example, the first unit cells 412 have a smaller cross-sectional area than the second unit cells 414. In some examples, the magnitudes of each of the width, length, and height of the structure of the unit cells fall within a range of one-eighth of an inch to one-quarter of an inch. However, a dimension of the unit cells may be smaller (e.g., one-tenth of an inch) or larger (e.g., one-half of an inch, one inch, etc.) in other examples. In some examples, the first structure and the second structure differ by any one or more of these variations in structure (e.g., shape, size, material, wall thickness).

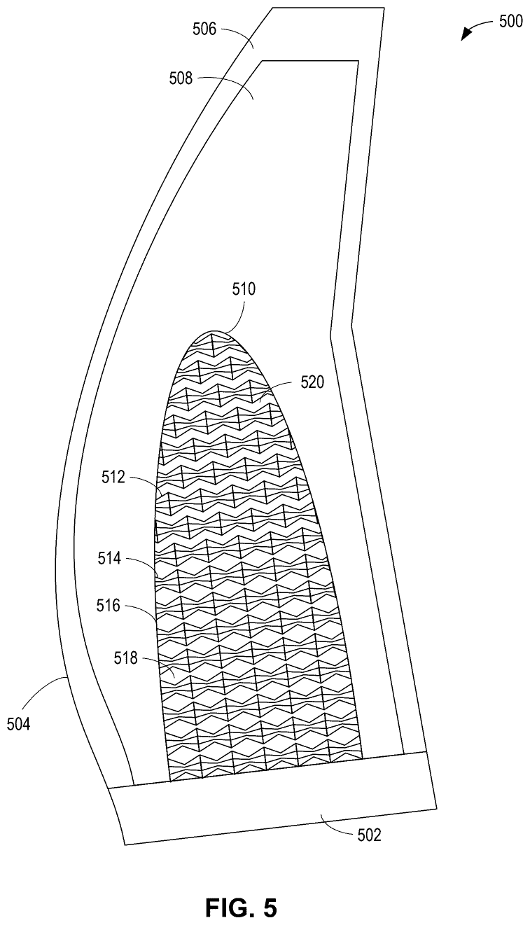

FIG. 5 is cross-sectional view of an example blade 500. The example blade 500 includes an example spar 502 connected to an airfoil 504, the airfoil 504 including an outer surface 506 defining an external contour of the blade 500. The outer surface 506 forms and/or otherwise defines an example inner cavity 508 therein. An example internal lattice structure 510 is disposed in the inner cavity 508. The internal lattice structure 510 includes a set 512 of unit cells 514. In the illustrated example of FIG. 5, the unit cells 514 have a hexagonal cross section, the size of the cross section varying throughout each unit cell 514 from a first size, down to a second size in the middle of each unit cell 514, and back up to the first size. In some examples, the shape of the cross section varies throughout each unit cell 514.

In the illustrated example of FIG. 5, the set 512 of unit cells 514 forms a complex (e.g., composite) three-dimensional structure. The set 512 of the unit cells 514 connect to a base 516. In the illustrated example of FIG. 5, the base 516 is a flexible sheet of material. In some examples, the base 516 is a set of unit cells. In some examples, the configuration of the unit cells 514 vary throughout the complex three-dimensional structure. For example, the configuration of the unit cells 514 varies throughout the internal lattice structure 510. At the bottom of the internal lattice structure 510, rows of the unit cells 514 are horizontally aligned such that one of the unit cells 514 is directly on top of a second of the unit cells 514. At the top of the internal lattice structure 510, adjacent rows of the unit cells 514 are horizontally offset. The configuration of the set 512 of unit cells 514 defines first cavities 518 and second cavities 520 between the unit cells 514. The first and second cavities 518, 520 contribute to the mechanical properties of the internal lattice structure 510, and therefore the blade 500. The configuration of the set 512 of unit cells 514 also varies in that there are fewer unit cells 514 in the rows at the top of the set 512 than at the bottom of the set 512. This affects the mechanical properties of the internal lattice structure 510, and therefore the blade 500, throughout the internal lattice structure 510. In the illustrated example of FIG. 5, the unit cells 514 are oriented in the same direction. In some examples, the orientation of the unit cells 514 varies throughout the internal lattice structure 510.

In some examples, the structure of the unit cells 514 varies throughout the internal lattice structure 510. For example, the size of the unit cells 514 can vary throughout the internal lattice structure 510. The unit cells 514 include surfaces defining a hollow space. In some examples, one or more of the surfaces of some of the unit cells 514 are removed. In some examples, one or more surfaces are added to the unit cells 514 to provide additional support. These variations in the structures of the unit cells 514 allow the internal lattice structure 510 to exhibit particular mechanical properties throughout the internal lattice structure 510.

In some examples, the internal lattice structure 510 includes a plurality of sets of unit cells. In some examples, a second set of unit cells forms a second complex three-dimensional shape. In some examples, the three-dimensional structure is specifically configured to exhibit mechanical properties that meet loading requirements imposed by environmental factors. In some examples, the complex three-dimensional structure is a metallic material, a composite material, or a combination of a metallic and composite materials. In some examples, the complex three-dimensional structure is formed by adhesive bonding, welding, brazing, additive manufacturing, and/or any combination of these methods of manufacture. In some examples, the complex three-dimensional structure is formed by cutting and shaping a single sheet of material.

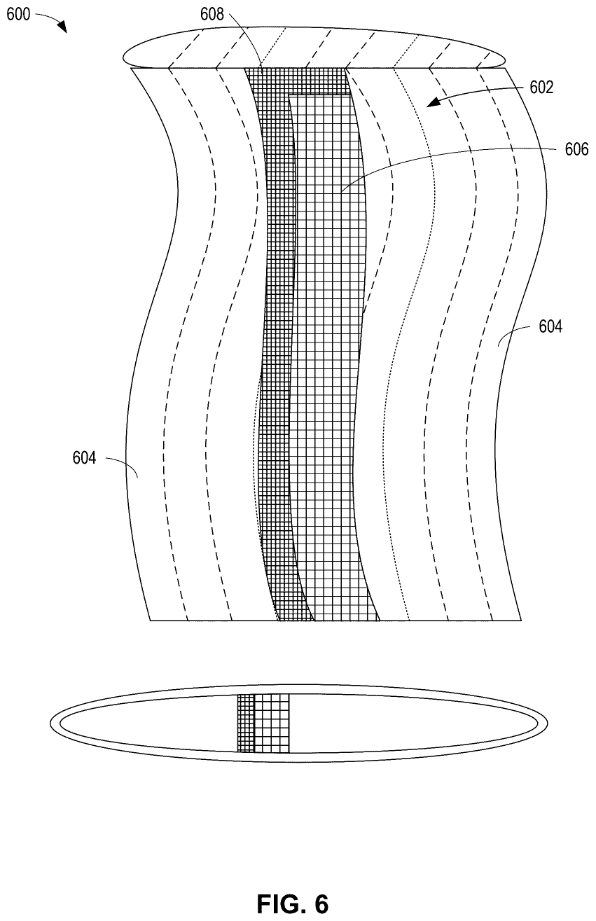

FIG. 6 is a cross-sectional view of an example blade 600, wherein the example blade 600 includes example latticed regions 602 and example non-latticed regions 604. In some examples, the internal cavity of the airfoil 304 (and/or the internal cavity of the spar 302) can include a latticed region 602 and a non-latticed region 604. In some examples, the non-latticed region 604 is hollow. In some examples, the non-latticed regions 604 include structural filler (e.g., dampening) material (e.g., foam, polyurethane, etc.) to provide additional stiffness. In some examples, the latticed regions 602 implement the internal lattice structure 310 described above. In the illustrated example, latticed regions 602 include first latticed region 606 including first unit cells and second latticed region 608 including second unit cells.

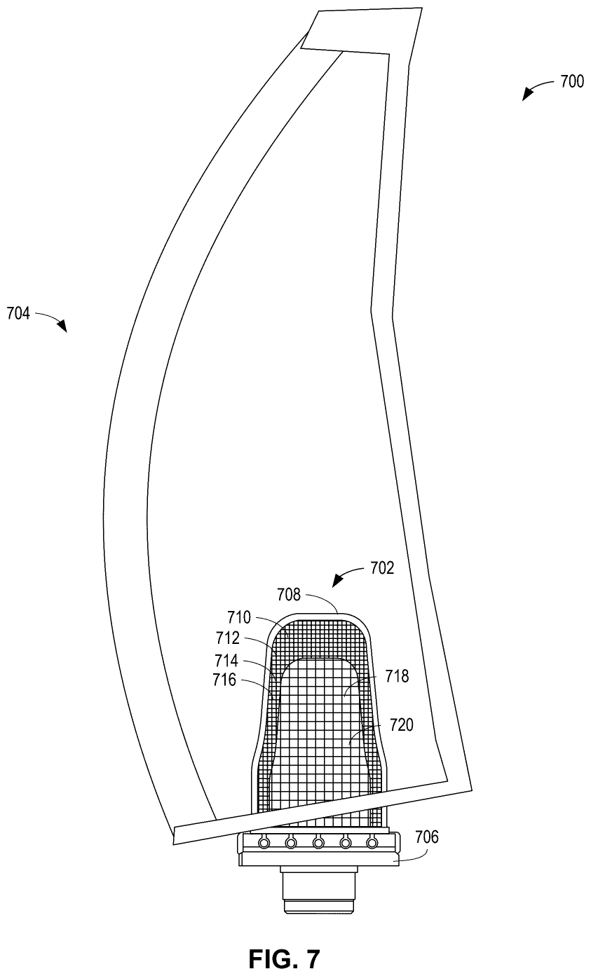

FIG. 7 is a cross-sectional view of an example blade 700. The example blade 700 includes a spar 702 connected to an airfoil 704 to form the blade 700. The airfoil 704 includes a first outer surface and an internal cavity. The spar 702 provides structural support to the airfoil 704 and carries loads separate from the loads carried by the airfoil 704. The spar 702 includes a rotor mount 706, a second outer surface 708) defining an external contour of the spar 702 and an internal cavity 710 of the spar 702, and a spar lattice structure 712 positioned in the internal cavity 710. In the illustrated example of FIG. 7, the spar lattice structure 712 includes a first set 714 of first unit cells 716 having a first structure and a second set 718 of second unit cells 720 having a second structure. In some examples, the spar lattice structure includes more than two sets of unit cells (e.g., three sets, four sets, etc.). In some examples, the spar lattice structure has only one set of unit cells. The structures of the unit cells of the spar lattice structure 712 can vary as described above in connection with the internal lattice structure 310 of the airfoil 304, according to the loading requirements experienced by the spar 702 in different locations within the spar 702.

In the illustrated example of FIG. 7, the airfoil 704 does not include an internal lattice structure. In some examples, the airfoil 704 includes an internal lattice structure including a set of unit cells, the unit cells having a structure. In some examples, the structures of the unit cells of the spar lattice structure 712 are different than the structures of the unit cells of the airfoil 704. In some examples, the spar lattice structure 712 extends into the airfoil 704 and/or is integrally formed with the internal lattice structure of the airfoil 704.

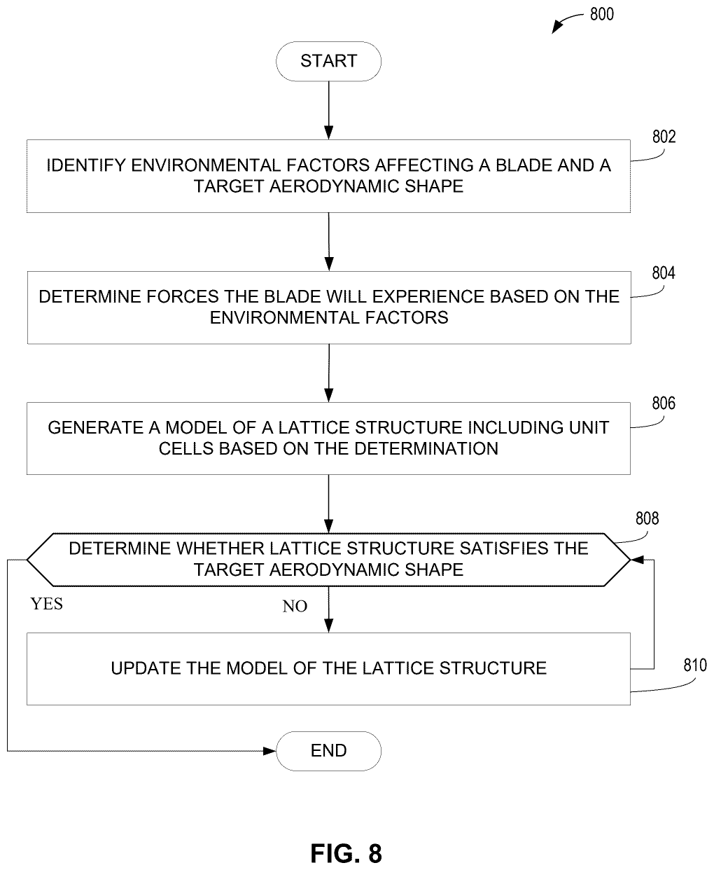

FIG. 8 is a flowchart representative of an example method 800 to generate the configuration of the example blade of FIGS. 1-2. At block 802, environmental factors affecting a blade and a target aerodynamic shape of the blade are identified. These environmental factors can include the weight of the aircraft and the engine, the size and shape of the blades, the optimal or maximum flight speed of the aircraft, the altitude the aircraft flies at, temperatures experienced during flight, target aero shape, etc. At block 804, the forces the blade is predicted to experience based on the environmental factors are determined. These forces include, but are not limited to, vibratory stresses, pressure loads, and FOD loads. In some examples, both the forces an airfoil of the blade is predicted to experience and the forces a spar of the blade is predicted to experience are determined. At block 806, a model of a lattice structure including unit cells is generated based on the forces. In some examples, the model of the lattice structure includes at least one of the material the lattice structure should be comprised of, the shape and/or size of the unit cells in the lattice structure, the position of the lattice structure within the blade, and a particular arrangement of the unit cells. At block 808, whether the lattice structure meets the target aerodynamic shape is determined. If the lattice structure is determined to not meet the target aerodynamic shape (e.g., block 808 returns a result of NO), the model of the lattice structure is updated based on the determination (block 810) and the method returns to block 808. If the lattice structure is determined to meet the target aerodynamic shape (e.g., block 808 returns a result of YES), the example method 800 terminates.

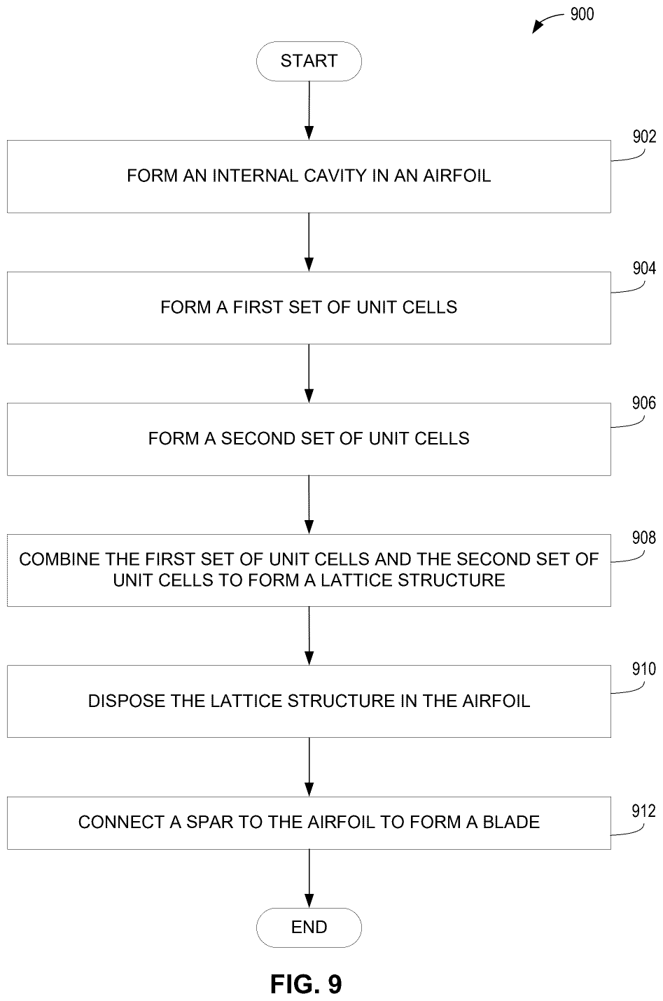

FIG. 9 is a flowchart representative of an example method 900 to manufacture the example blade of FIGS. 1-2. At block 902, an internal cavity is formed in an airfoil. At block 904, a first set of unit cells is formed. In some examples, the first set of unit cells is formed via adhesive bonding, welding, brazing, additive manufacturing, or a combination of these manufacturing methods. In some examples, the first set of unit cells are specifically designed to exhibit particular mechanical properties identified as beneficial for the blade. For example, the first unit cells may be a certain shape, wall thickness, size, material, etc. At block 906, a second set of unit cells is formed. In some examples, the second set of unit cells have a different structure than the first set of unit cells. For example, the first set of unit cells can be honeycomb-shaped and the second set of unit cells can be cross-cube shaped. At block 908, the first set of unit cells and the second set of unit cells are combined to form a lattice structure. At block 910, the lattice structure is disposed in the internal cavity of the airfoil. At block 912, a spar is connected to the airfoil to form the blade. In other examples, the spar is integrally formed with the airfoil. Then, method 900 terminates.

From the foregoing, it will be appreciated that example systems, apparatus, articles of manufacture, and methods have been disclosed that provide for increased thrust-to-weight ratio of an aircraft using an airfoil with a hollow skin and an internal lattice structure. Examples disclosed herein provide for selective placement of lattice structures within an airfoil to tailor the mechanical properties of the airfoil according to loading requirements imposed by environmental factors. Examples disclosed herein further provide for improved strength to weight ratio of airfoils, increased energy absorption, reduced stress propagation, and reduced thermal conductivity of airfoils.

Further aspects are provided by the subject matter of the following clauses:

A blade includes a spar and an airfoil coupled to the spar, the airfoil including: an outer surface defining an external contour of the airfoil and defining an inner cavity; and an internal lattice structure arranged in the inner cavity, the internal lattice structure including: a first set of at least two adjacent first unit cells at a first location, the first unit cells having a first structure; and a second set of at least two adjacent second unit cells at a second location, the second set different than the first set, the second unit cells having a second structure different than the first structure, wherein the first structure and the second structure are based on at least one environmental factor impacting the respective first and second locations of the airfoil.

The blade of any preceding clause, wherein the first set has a first stiffness and the second set has a second stiffness greater than the first stiffness.

The blade of any preceding clause, wherein the first structure includes first walls intersecting at respective first vertices, and the second structure includes second walls intersecting at respective second vertices, the second walls are thicker than the first walls and the second vertices are thicker than the first vertices.

The blade of any preceding clause, wherein the second structure is a different shape than the first structure.

The blade of any preceding clause, wherein the second structure is honeycomb shaped and the first structure is cross-cube shaped.

The blade of any preceding clause, wherein the internal lattice structure is formed from a sheet of material, the first set and the second set is formed by folding and cutting of the sheet of material.

The blade of any preceding clause, wherein the first unit cells are a first material and the second unit cells are a second material.

The blade of any preceding clause, wherein the outer surface is a first material, and the internal lattice structure is a second material different than the first material.

The blade of any preceding clause, wherein the inner cavity includes a first region and a second region, the internal lattice structure is in the first region of the inner cavity, and a filler material is in the second region of the inner cavity, the second region being a non-latticed region.

The blade of any preceding clause, wherein the internal lattice structure is a first internal lattice structure, and wherein the spar includes a second internal lattice structure.

The blade of any preceding clause, wherein the second internal lattice structure is integrally formed with the first internal lattice structure.

The blade of any preceding clause, wherein the first unit cells of the first set form a complex 3D structure, the complex 3D structure configured based on one or more of the at least one environmental factor impacting the airfoil.

An airfoil includes an outer skin defining an internal cavity and an internal lattice structure in the internal cavity including: a first latticed region including at least two adjacent first unit cells having a first structure; and a second latticed region including a at least two second unit cells having a second structure different than the first structure.

The airfoil of any preceding clause, wherein the internal cavity includes a non-latticed region.

The airfoil of any preceding clause, further including filler material in the non-latticed region.

The airfoil of any preceding clause, wherein the filler material is one of foam or polyurethane.

The airfoil of any preceding clause, wherein the first structure is smaller than the second structure.

The airfoil of any preceding clause, wherein the first structure is a different shape than the second structure.

The airfoil of any preceding clause, wherein the first latticed region and the second latticed region are formed from one sheet of material, the first unit cells and the second unit cells formed by folding and cutting of the sheet of material.

The airfoil of any preceding clause, wherein the first unit cells of the first latticed region form a complex 3D structure, the complex 3D structure configured based on at least one environmental factor impacting the airfoil.

A method for designing a blade with internal lattice structure including identifying at least one environmental factor affecting a blade; determining forces the blade will experience based on the at least one environmental factor; and generating a model of a lattice structure including unit cells based on the determination.

The method for designing a blade with internal lattice structure of any preceding clause, further including identifying a target aerodynamic shape and determining whether the lattice structure satisfies the target aerodynamic shape.

The method for designing a blade with internal lattice structure of any preceding clause, further including updating the model of the lattice structure based on a determination the lattice structure does not satisfy the target aerodynamic shape.

The method for designing a blade with internal lattice structure of any preceding clause, wherein the lattice structure includes a first latticed region and a second latticed region.

A method for manufacturing a blade with internal lattice structure including forming an internal cavity in an airfoil; forming a set of unit cells; disposing the set of unit cells in the airfoil; and connecting a spar to the airfoil.

The method for manufacturing a blade with internal lattice structure of any preceding clause, further including forming a second set of unit cells and disposing the second set of unit cells in the airfoil.

The method for manufacturing a blade with internal lattice structure of any preceding clause, further including disposing a filler material in the airfoil.

The method for manufacturing a blade with internal lattice structure of any preceding clause further including forming a spar cavity in the spar; forming spar unit cells; and disposing the spar unit cells in the spar.

The method for manufacturing a blade with internal lattice structure of any preceding clause, wherein the spar unit cells are first spar unit cells, further including forming second spar unit cells and disposing the second spar unit cells in the spar cavity.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A blade, comprising:
a spar; and
an airfoil coupled to the spar, the airfoil including:
an outer surface defining an external contour of the airfoil and defining an inner cavity; and
an internal lattice structure arranged in the inner cavity, the internal lattice structure including:
a first set of at least two adjacent first unit cells at a first location, the first unit cells having a first structure; and
a second set of at least two adjacent second unit cells at a second location, the second set different than the first set, the second unit cells having a second structure different than the first structure,
wherein the first structure and the second structure are based on at least one environmental factor impacting the respective first and second locations of the airfoil.

2. The blade of claim 1, wherein the first set has a first stiffness and the second set has a second stiffness greater than the first stiffness.

3. The blade of claim 1, wherein the first structure includes first walls intersecting at respective first vertices, and the second structure includes second walls intersecting at respective second vertices, the second walls are thicker than the first walls and the second vertices are thicker than the first vertices.

4. The blade of claim 1, wherein the second structure is a different shape than the first structure.

5. The blade of claim 4, wherein the second structure is honeycomb shaped and the first structure is cross-cube shaped.

6. The blade of claim 1, wherein the internal lattice structure is formed from a sheet of material, the first set and the second set is formed by folding and cutting of the sheet of material.

7. The blade of claim 1, wherein the first unit cells are a first material and the second unit cells are a second material.

8. The blade of claim 1, wherein the outer surface is a first material, and the internal lattice structure is a second material different than the first material.

9. The blade of claim 1, wherein the inner cavity includes a first region and a second region, the internal lattice structure is in the first region of the inner cavity, and a filler material is in the second region of the inner cavity, the second region being a non-latticed region.

10. The blade of claim 1, wherein the internal lattice structure is a first internal lattice structure, and wherein the spar includes a second internal lattice structure.

11. The blade of claim 10, wherein the second internal lattice structure is integrally formed with the first internal lattice structure.

12. The blade of claim 1, wherein the first unit cells of the first set form a complex 3D structure, the complex 3D structure configured based on one or more of the at least one environmental factor impacting the airfoil.

13. An airfoil, comprising:
an outer skin defining an internal cavity; and
an internal lattice structure in the internal cavity including:
a first latticed region including at least two adjacent first unit cells having a first structure; and
a second latticed region including at least two second unit cells having a second structure different than the first structure.

14. The airfoil of claim 13, wherein the internal cavity includes a non-latticed region.

15. The airfoil of claim 14, further including filler material in the non-latticed region.

16. The airfoil of claim 15, wherein the filler material is one of foam or polyurethane.

17. The airfoil of claim 13, wherein the first structure is smaller than the second structure.

18. The airfoil of claim 13, wherein the first structure is a different shape than the second structure.

19. The airfoil of claim 13, wherein the first latticed region and the second latticed region are formed from one sheet of material, the first unit cells and the second unit cells formed by folding and cutting of the sheet of material.

20. The airfoil of claim 13, wherein the first unit cells of the first latticed region form a complex 3D structure, the complex 3D structure configured based on at least one environmental factor impacting the airfoil.
